(19) United States
(12) Patent Application Publication
(10) Pub. No.: US 2006/0138187 A1
(43) Pub. Date: Jun. 29, 2006

(54) Attachment devices and associated ornaments for attaching ornaments to a vehicle

(76) Inventor: Richard M. Love, Atlanta, GA (US)

Correspondence Address: SUTHERLAND ASBILL & BRENNAN LLP, 999 PEACHTREE STREET, N.E., ATLANTA, GA, 30309, US

(21) Appl. No.: 11/285,407

(22) Filed: Nov. 22, 2005

Related U.S. Application Data
(60) Provisional application No. 60/630,125, filed on Nov. 22, 2004.

(51) Int. Cl. B60R 11/00; B60R 7/00; B60R 9/00

(52) U.S. Cl. 224/572

(57) ABSTRACT

A device for attaching an ornament to a vehicle and method for using and manufacturing such a device. The device includes a backbone with an ornament attached to the front of the backbone. The device also includes one or more straps attached to the backbone. Each of the straps have at least two unattached ends which are used to attach the backbone to a vehicle.

### FIELD OF THE INVENTION

The present invention relates to a device for attaching an ornament to a vehicle such as an automobile.

### BACKGROUND OF THE INVENTION

Many people enjoy decorating vehicles for various activities such as sporting events, holidays, family celebrations. Many still decorate vehicles simply for aesthetics or to provide a message to which they subscribe (e.g., supporting political candidate, philosophical ideology, etc). However, the current methods of decorating a vehicle have significant drawbacks. Many decorations must be permanently affixed to the vehicle or may cause damage to the exterior of the vehicle in their application or removal (e.g., hood emblems, stickers, paint, etc.). Many installations of ornaments such as emblems and license plates require the use of tools and/or nuts and bolts, which result in installations that are not easily and quickly installed, removed, or replaced.

Often when people are attaching ornaments to the exterior of their vehicle they do so in unreliable and unsecured ways including using string or yard to tie to the roof of a vehicle or anywhere a loop may be made, wedging an ornament or attachment to an ornament in a “rolled up” window, as well as other make-shift techniques. This form of jury-rigging attachments of ornaments to a vehicle are unstable and unreliable. What is needed is a device which allows people to attach ornamental decorations to their vehicle which addresses these shortcomings of the prior art.

### BRIEF DESCRIPTION OF THE INVENTION

According to an embodiment of the invention, there is disclosed a device for attaching an ornament to a vehicle that includes a backbone with an ornament attached to the front of the backbone. The device also includes one or more straps attached to the backbone. Each of the straps have at least two unattached ends which are used to attach the backbone to a vehicle. In accordance with another aspect of the invention, the first and second ends of each strap may include snaps, hooks, buckles, knots, alligator clips, or velcro.

In accordance with yet another aspect of the invention, the device further includes a second strap attached to the backbone, where the second strap has an unattached first end and an unattached second end. The second strap is attached to the vehicle by engaging the first and second ends of the second strap. In accordance with another aspect of the invention, the first and second ends of the second strap may include snaps, hooks, buckles, knots, alligator clips, or velcro.

In accordance with yet another aspect of the invention, a strap is attached to the vehicle by engaging the unattached first end or unattached second end directly to the vehicle. According to another aspect of the invention, a strap is attached to the vehicle by engaging the unattached first end and unattached second end directly to each other. In accordance with yet another aspect of the invention one or more straps are adjustable in relation to the backbone and/or are removable from the backbone entirely. According to yet another aspect of the invention, the backbone contains one or more eyelets, where at least one of the eyelets attaches the backbone to an ornament.

According to another embodiment of the invention, there is disclosed a method of manufacturing a device for attaching an ornament to a vehicle, which includes the steps of providing a backbone containing one or more eyelets; attaching an ornament to the backbone using one or more of the eyelets; and providing one or more straps attached to a portion of the backbone, where each strap has an unattached first end and an unattached second end.

According to yet another embodiment of the invention, there is disclosed a method of using a device for attaching an ornament to a vehicle, which includes the steps of providing a backbone; attaching an ornament to the backbone; providing one or more straps attached to a portion of the backbone, where each strap has unattached first and second ends; and attaching one or more straps to a vehicle by engaging the first and second ends of each strap.

### BRIEF DESCRIPTION OF THE DRAWINGS

Having thus described the invention in general terms, reference will now be made to the accompanying drawings, which are not necessarily drawn to scale, and wherein:

FIG. 1 is a frontal view of an ornament attachment device in accordance with an exemplary embodiment of the present invention.

FIG. 2 is a side view of an ornament attachment device in accordance with an exemplary embodiment of the present invention.

FIG. 3 is a drawing demonstrating the connection of an ornament to the attachment device in accordance with an exemplary embodiment of the present invention.

FIG. 4 is a drawing displaying two exemplary forms of straps of the attachment device in accordance with exemplary embodiments of the present invention.

FIG. 5 is a drawing displaying a flexible vertebrae for the backbone of the attachment device in accordance with an exemplary embodiment of the present invention.

FIG. 6 is a drawing demonstrating the adjustable buckle on the straps of the attachment device in accordance with an exemplary embodiment of the present invention.

FIGS. 7-13 are drawings demonstrating several exemplary forms of strap ends used as a means for attaching the attachment device to a car in accordance with exemplary embodiments of the present invention.

FIGS. 14 and 15 are drawings showing exterior portions of an automobile to which the attachment device will be connected in accordance with exemplary embodiments of the present invention.

FIG. 16 is a drawing displaying an attachment device engaged with the front end of a car in accordance with an exemplary embodiment of the present invention.

### DETAILED DESCRIPTION OF THE INVENTION

The exemplary embodiments described herein relate to a device for attaching an ornament to a vehicle such as an automobile. The exemplary embodiments will be discussed with particular reference to the attachment to the front of a car. However, as one skilled in the art would appreciate, the invention may also be adapted to allow attachment to various locations on a car (e.g., the back end of the car, windows, tires, sun roof, etc.), or attachment to other vehicles, such as motorcycles, boats, SUVs (sports utility vehicles), ATVs (all terrain vehicles), trucks, planes, trains, etc.

The present invention will be described below with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

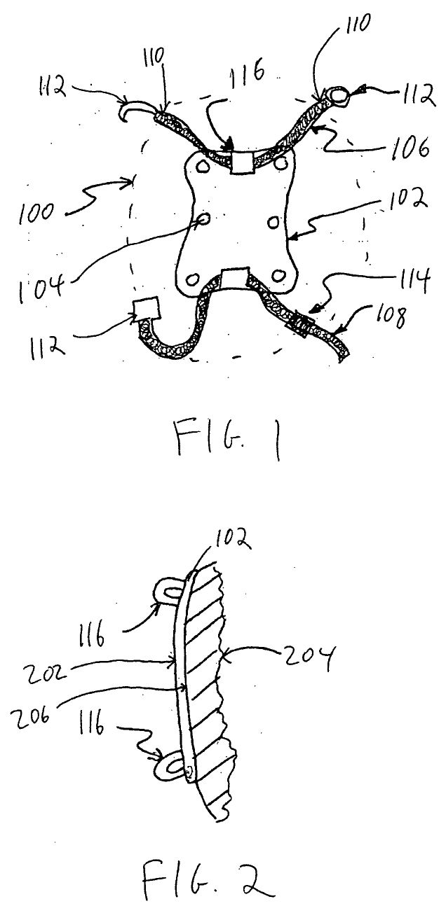

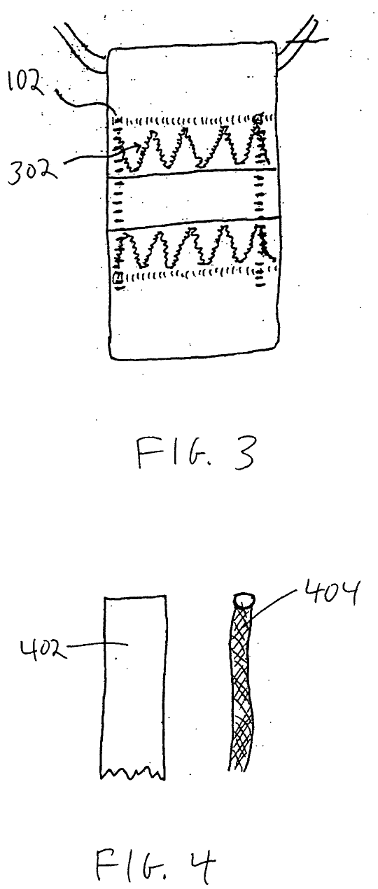

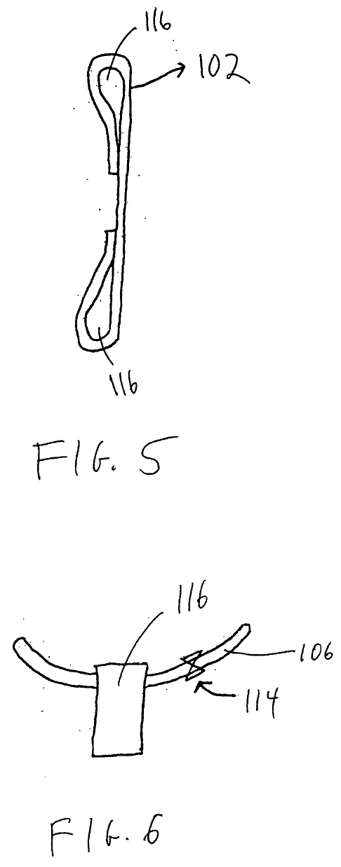

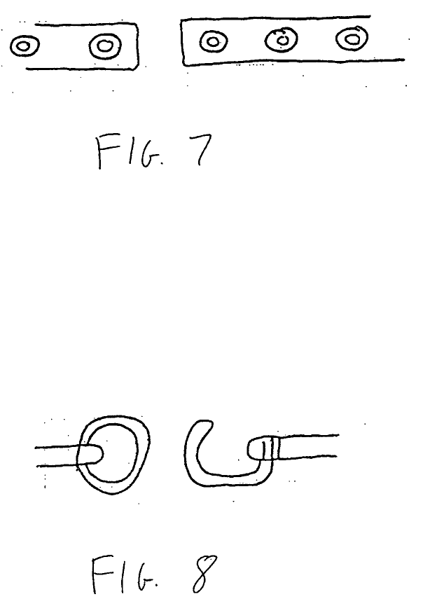

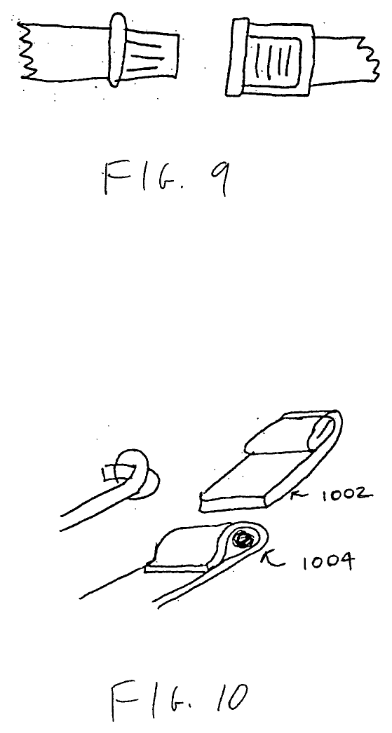

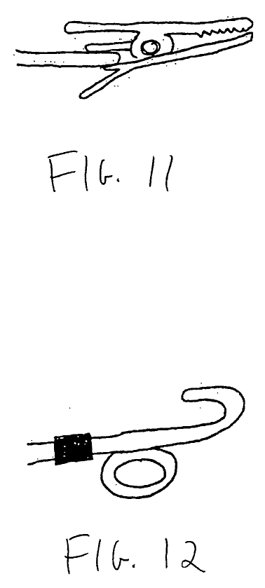

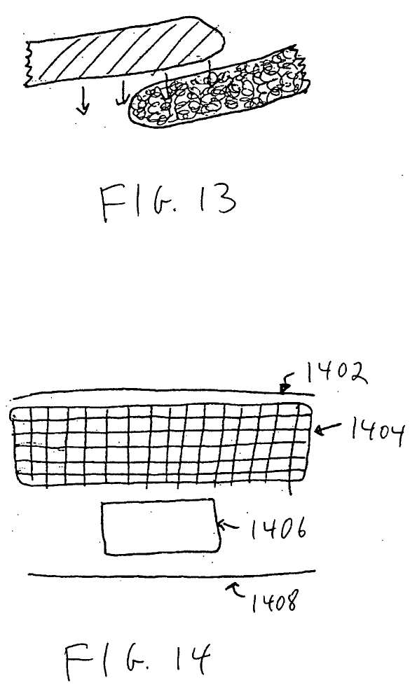

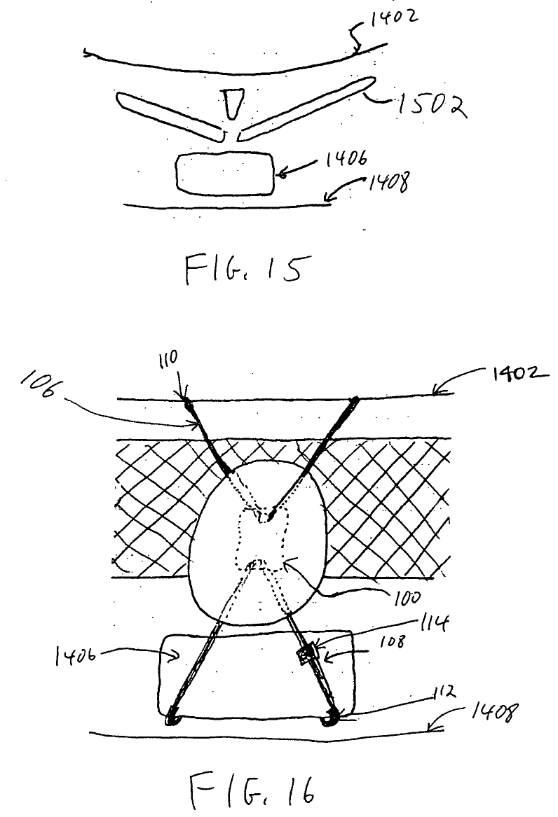

As shown in FIG. 1, the attachment device 100 consists of a backbone 102 that provides rigid support for an ornament (not pictured) when it is attached to a vehicle such as an automobile. The backbone 102 also provides a flush backing for the ornament when attached to the car. One of ordinary skill in the art will appreciate that the backbone 102 can be made of various materials and molded/configured into a variety shapes for reasons including custom fitting an ornament to the car, protecting both the car and ornament from damage such as scratching, puncture, or other reasons appreciable by one of ordinary skill in the art. One of ordinary skill in the art would also appreciate the various forms of materials the backbone 102 could be made out of to either provide a more rigid vertebrae (e.g., metal, plastics, etc.) for the ornament or a more flexible vertebrae (e.g., nylon fabric straps, rubber pieces, etc.) for the ornament depending on the desired appearance of the attached ornament on the car. The backbone 102 may also comprise a pliable material such that the backbone 102 can be customized to fit the contour of the surface to which it will rest.

In the exemplary embodiment displayed in FIG. 1, the backbone 102 contains one or more eyelets 104. These eyelets 104 may provide the attachment means for an ornament to be attached to the backbone 102. It is also appreciable that the ornament may be attached to the backbone 102 with or without the use of eyelets 104 (e.g., velcro). Also displayed in the exemplary embodiment of FIG. 1, are a first strap 106 and second strap 108, (also referred to as an up-strap and a down-strap, respectively) attached at opposite ends of the backbone 102. The straps 106 and 108 are what complete the connection of the backbone 102 to the section of the car where the ornament is to attach. While the embodiment displayed in FIG. 1 shows the use of two straps 106 and 108, it may be appreciated that only one strap may be required for attachment of the backbone 102 to a vehicle. Alternatively, one of ordinary skill in the art may also appreciate that the addition of straps (e.g., a third, forth, etc.) may provide more secure attachments. These straps are connected to the backbone 102 in such a way that both ends 110 of each strap are unattached. The unattached ends of the strap have end pieces 112 that provide attachment either to a corresponding end piece 112 or directly to the car. In the exemplary embodiment shown in FIG. 1, the straps 106 and 108 are connected by corresponding eye pieces 116. As shown in the exemplary embodiment of FIG. 1 the straps contain an adjustable buckle 114 to allow for a more (or less) secure attachment to the car. The straps can be made of cording material, elastic material, or another type of strap material known by one of ordinary skill in the art. In an exemplary embodiment, the straps are made of material that provides at least some elasticity. The greater the elasticity in the straps, the greater the range of locations on a car the ornament can attach.

In various embodiments of the invention, the ornaments attached to the backbone of the attachment device may comprise figures of mascots of sports teams (professional and collegiate), holiday symbols or figures (e.g., Santa Claus, Jack-o-Lanterns, etc.), well-known cartoon characters or celebrity caricatures. Other ornaments may include but are not limited to patriotic symbols, symbols of nationality, corporate logos, novelty items (e.g., personifying the car with eyes, glasses, mustache, nose, mouth, etc. to give the car the illusion of having a face or even an animal appearance by using a tail, wings, feathers, etc.), and other generic items, etc. These ornaments can be made out of washable material, weather resistant material, mold resistant material, flame-resistant, paint/finish-friendly material (e.g., does not scratch the car, etc.), or any other material appreciated by one of ordinary skill in the art. One of ordinary skill in the art will appreciate that more elaborate and complex ornaments could also be displayed using the attachment device to attach them to a car (e.g., ornaments with electronic displays, moving parts, audio, etc.)

The attachment device 100 may also be modified to allow for a wider variety of ornamental displays. For example, in an alternative embodiment a power supply (such as a battery pack) may be integrated into or attached to the backbone 102 of the attachment device 100 to power ornaments containing electric motors and/or controllers to provide movement to an attached ornament with moveable elements or to provide controlled illumination of lights or a display (e.g., the hand of a cartoon figure waving, or the jaw of an alligator snapping, blinking lights, displaying messages on a screen, etc.). Another example could be a speaker associated with the ornament and/or the attachment device 100 (e.g., built into the backbone or the ornament itself) to allow for the generation of audio signals coming from the ornament such as a song.

Other examples could include wireless signal receivers (Bluetooth antennas, 802.11x wireless cards, etc.) or various forms of sensors (e.g., infra red sensors, RF sensors, etc.) built into the ornament and/or the attachment device 100 to provide ornaments with electronic displays to receive wireless signals and display the information received on the ornament. In an alternative embodiment, the receivers or sensors accept signals that either contain instructions or trigger an action for the ornament to perform various operations (e.g., blink lights, play a team fight song, etc.). Another example would be to include a solar cell associated with the ornament and/or the attachment device that could provide small amounts of power to allow an ornament to perform some task requiring power. Those skilled in the art will appreciate various other mechanical and electrical features that could be integrated into the attachment device to provide a more elaborate ornamental display.

FIG. 2 shows a side view of an ornament attachment device in accordance with an exemplary embodiment of the present invention. As shown in the exemplary embodiment of FIG. 2 the eye pieces 116 are connected to the backside 202 of the backbone 102 while the ornament 204 is connected to the front side 206 of the backbone 102.

FIG. 3 is a drawing demonstrating connection of an ornament to the attachment device in accordance with an exemplary embodiment of the present invention. In the exemplary embodiment displayed in FIG. 3 the ornament is stitched (typically nylon stitching 302) directly to the backbone 102. However, one of ordinary skill in the art could appreciate other methods of attaching an ornament to the front side 206 of the backbone 102 (e.g., staples, straps, glue, soldering, tacking etc.). In another embodiment of the attachment device, the backbone 102 could be outfitted with a means of attaching the ornament that allow for the easy removal or substitution of an ornament while not removing the attachment device from the car. These quick release attaching means could comprise straps, form fitting plastic snaps, velcro or any other means of attachment appreciable by one of ordinary skill in the art that allow for the quick release of an ornament.

FIG. 4 is a drawing displaying two exemplary forms of straps of the attachment device in accordance with exemplary embodiments of the present invention. The two exemplary forms of straps shown in FIG. 4 are a nylon strap 402 and a bungee cord 404. Other forms of straps appreciable by one of ordinary skill in the art may be utilized in alternative embodiments of the attachment device.

FIG. 5 is a drawing displaying a flexible vertebrae for the backbone 102 of the attachment device in accordance with an exemplary embodiment of the present invention. As shown in FIG. 5, a strap may be used as a flexible backbone 102 and for creation of the eye pieces 116. The use of a flexible backbone 102 allows for a more flush connection to the contour of the attachment portion of the outside of a vehicle, such as the front end of a car.

FIG. 6 is a drawing demonstrating the adjustable buckle on the straps of the attachment device in accordance with an exemplary embodiment of the present invention. As shown in the exemplary embodiment of FIG. 6, the strap 106 (or another strap such as strap 108) running through the eye piece 116 contains an adjustable buckle 114 to allow for a more (or less) secure attachment to the car. One of ordinary skill in the art will appreciate that allowing the straps to be adjustable (or removable) through the use of the adjustable buckle 114 may enable various attachment configurations on a car. In alternative embodiments, the backbone itself may be adjustable through the use of an adjustable buckle 114 to enable various attachment configurations on a car.

FIGS. 7-13 are drawings demonstrating several exemplary forms of strap ends used as a means for attaching the attachment device to a car in accordance with exemplary embodiments of the present invention. FIGS. 7-13 all show various end pieces 112 that are used to attach the attachment device to the car. At the ends of the straps can be various end pieces for completing the attachment of the ornament to the car. Many of these end pieces provide quick releasing allowing for easy replacement or removal of the ornamental device. These end pieces include snaps (FIG. 7), hooks (FIG. 8), buckles (FIG. 9), knots and/or overlaps 1002 and dowels 1004 (FIG. 10), alligator clips (FIG. 11), ring-hook combinations (FIG. 12), and velcro (FIG. 13), etc. Those of ordinary skill in the art will appreciate other means of attaching the two ends of a strap to allow for a sturdy, yet quickly removable attachment. Moreover, in an alternative embodiment, straps for connecting the attachment device to the car may be aided (or rendered unnecessary) by the use of magnets (e.g., having a backbone with a magnetic backside to facilitate the connection to the car).

In other alternative embodiments of the present invention, the end pieces 110 of the straps may be interchangeable to allow for a more customized fit to a vehicle. Alternatively, the entire strap may be both removable and interchangeable. For example, a user may use one strap with snaps at its ends to attach around one location on a vehicle (e.g., grill) and using another strap with alligator clips at its ends at attach to another location on the vehicle (e.g., the license plate).

FIGS. 14 and 15 are drawings showing exterior portions of an automobile to which the attachment device will be connected in accordance with exemplary embodiments of the present invention. In particular, FIGS. 14 and 15 both show typical front ends (i.e., fenders) of an automobile where an ornament may attach to a car in accordance with the present invention. FIG. 14 shows a typical front end of a car containing a grill. The front end of a car depicted in FIG. 14 shows a hood seam 1402, a grill 1404, and a license plate holder 1406, and fender 1408. FIG. 15 shows a typical front end of a car with no grill, rather the front end of a car depicted in FIG. 15 shows slots 1502 (or vents) instead of a grill. In alternative embodiments of the invention, the attachment device may be connected to other areas of the exterior or a car as well as to other configurations of the exterior of a car. To complete the attachment to the car the ends of the straps of an attachment device can attach to each other after being threaded or looped to a part of the car (e.g., through opening in the grill 1404, or slots 1502 in fender, etc.). In an alternative embodiment, the ends of the straps can be attached directly to the car (e.g., clamping to the grill 1404, fender or frame or hooking to the bottom of the fender 1408 or front end license plate holder 1406, etc.), rather than connected to each other. Further, in an exemplary embodiment, the hood seam 1402 of a car could be used to provide further attachment security and attachment redundancy.

FIG. 16 is a drawing displaying an attachment device 100 engaged with the front end of a car in accordance with an exemplary embodiment of the present invention. In the embodiment shown in FIG. 16, the attachment device 100 is attached (or mounted) to the car by first popping or releasing the hood, and inserting a knotted-end strap into the open hood seam 1402. The hood is then closed, which holds the up-strap 106 in place, and prevents the ends 110 from sliding together. The down-strap 108 has hook end pieces 112 at its ends 110. The down-strap 108 is then stretched to connect or “hook” under the front end license plate holder 1406. An adjustment buckle 114 on the down-strap 108 is drawn as tight as possible to hold the down-strap 108 tightly in place.

Many other modifications and additional features will also become evident in view of the preceding description of exemplary embodiments of the invention. It should be appreciated that many features and aspects of the present invention are described above by way of example only and are therefore not intended to be interpreted as required or essential elements of the invention, unless so stated. Accordingly, the foregoing relates only to certain embodiments of the invention and numerous changes may be made therein without departing from the spirit and scope of the invention as defined by the claims.

What is claimed is:

1. A device for attaching an ornament to a vehicle comprising:
a backbone, wherein the front side of the backbone is connected to an ornament;
at least one strap attached to the backbone, wherein the at least one strap has an unattached first end and an unattached second end; and
wherein the at least one strap is attached to the vehicle by engaging the first and second ends of the at least one strap.

2. The device of claim 1, wherein said first and second ends of said first strap are selected from a group consisting of snaps, hooks, buckles, knots, alligator clips, and velcro.

3. The device of claim 1, further comprising a second strap attached to the backbone, wherein the second strap has an unattached first end and an unattached second end, and wherein the second strap is attached to the vehicle by engaging the first and second ends of the second strap.

4. The device of claim 3, wherein said first and second ends of said second strap are selected from a group consisting of snaps, hooks, buckles, knots, alligator clips, and velcro.

5. The device of claim 1, wherein the first strap is attached to the vehicle by engaging the unattached first end or unattached second end directly to the vehicle.

6. The device of claim 1, wherein the first strap is attached to the vehicle by engaging the unattached first end and unattached second end directly to which each other.

7. The device of claim 1, wherein the at least one strap is adjustable in relation to the backbone or is removable from the backbone.

8. The device of claim 1, wherein the backbone contains a plurality of eyelets and wherein at least one of the plurality of eyelets attach the backbone to an ornament.

9. A method of manufacturing a device for attaching an ornament to a vehicle comprising:
providing a backbone, wherein the backbone contains a plurality of eyelets;
attaching an ornament to the backbone using at least one of the plurality of eyelets; and
providing at least one strap attached to a portion of the backbone, wherein the at least one strap has an unattached first end and an unattached second end.

10. A method of using a device for attaching an ornament to a vehicle comprising:
providing a backbone;
attaching an ornament to the backbone;
providing at least one strap attached to a portion of the backbone, wherein the at least one strap has an unattached first end and an unattached second end; and
attaching the first strap to the vehicle by engaging the first and second ends of the first strap.
